(19) United States
(12) Patent Application Publication
(10) Pub. No.: US 2003/0085555 A1
(43) Pub. Date: May 8, 2003

(54) Air bag covering assembly and method and apparatus for the production of an air bag covering

(76) Inventor: Jose M. Segura, Barcelona (ES)

Correspondence Address: Mr. Anthony Niewyk, Baker & Daniels, Suite 800, 111 East Wayne Street, Fort Wayne, IN, 46802, US

(21) Appl. No.: 10/308,048

(22) Filed: Dec. 2, 2002

Related U.S. Application Data
(62) Division of application No. 09/650,627, filed on Aug. 30, 2000, now abandoned.

(30) Foreign Application Priority Data
Dec. 7, 1999 (DE) 199 58 865.1

(51) Int. Cl. B60R 21/20

(52) U.S. Cl. 280/728.3

(57) ABSTRACT

In an air bag covering assembly for vehicles, with a carrier layer having break lines, the subject invention includes a splinter protection part on the side of the carrier layer that faces the air bag. The splinter protection part is made from a substantially splinter-free elastic material and extends over the covering zone. The carrier layer as well as the splinter protection party are joined throughout on their adjoining surfaces, and the splinter protection part is joined to the vehicle by a connecting strap. In this way, a formation of fragments is avoided, especially in the case of rigid breakage-prone carrier layers. With the assembly and the process for the production of an air bag device there is made possible the production of same without intermediate removal from a mold base part.

### FIELD OF THE INVENTION

This invention relates to an air bag cover for use with motor vehicles with a carrier layer formed with desired break lines in a cover area of an airbag. The invention relates, further, to a method and apparatus for the production of an air bag covering device with a mold base part as well as a mold counterpart for enclosing a mold cavity. The invention relates, further, to a method for the production of an air bag covering device

### BACKGROUND OF THE INVENTION

From DE 196,23 579 A1 there is known an air bag cover for motor vehicles, constructed as a control panel which ahs at its disposal a carrier layer formed in the impact zone of an air sack, also called airbag, with desired brake lines as well hinge lines. On activation of an air bag unit receiving the air gag, the expanding air bag strikes against the carrier layer, which breaks open along the hinge lines, so that the expanding air bag can enter the interior space of a motor vehicle. With such a formation of an air bag cover, to be sure, an expanding air bag will pass through the dashboard and into the interior of the motor vehicle. As a result, there is the danger that fragments will break off from the carrier layer and endangering the occupants of the motor vehicle, be flung into the interior space.

Underlying the invention is the problem of creating an air bag covering device of the type mentioned at the outset, which avoids endangering the occupants of a vehicle through the detachment of fragments on the passage of an air bag though the carrier and which provides an aesthetically pleasing appearance, especially when the carrier layer is manufactured from a relatively hard, rigid, breakage-prone material as is present in a vehicle at relatively low temperatures.

Further underlying the invention is the problem of providing a method and apparatus for the production of such an airbag cover which permits a relatively economical manufacture, that can be carried out in short cycle times.

### SUMMARY OF THE INVENTION

These and other problems are solved by the subject invention, wherein there is provided an air bag having a splinter protection part on the side of the carrier layer facing the air bag. The splinter protection part is made of substantially splinter-free elastic material, in which the splinter protection part extends at least over the area; the carrier layer and the splinter protection part are joined with one another over all adjoining surfaces, and the splinter protection part has at least one connecting section which is connectable with the motor vehicle.

Further, the invention includes an apparatus of the production of an air bag cover by a first mold part, which with the mold base part encloses a first cavity; a second mold counter part is provided which encloses with the mold base part a second cavity following upon the first cavity, in which system the cavities form the cavity space for the air bag cover device.

The invention further includes a process for the production of an air bag cover comprising the steps of forming a splinter protection part in a first cavity of a mold and after a cooling period, forming a carrier layer in a second cavity following upon the first cavity. The cooling is conducted so as to join the carrier layer and the splinter protection part over all of the adjoining surfaces.

Because the air bag cover of the subjection invention has an especially rigid carrier layer which under some circumstances may be highly subject to splinter damages at low operating temperatures of, for example, −10° C., emplaced in the impact zone of the air bag is an elastic and resilient splinter protection part joined over its full surface with the carrier layer, so that the bursting off of splinter pieces from the carrier layer on expansion and passage of the air bag can be prevented. In the carrier layer cracks can form which, lead to no endangerment of the parts of a motor vehicle, since the detachment of fragments is prevented by their adhesion to the splinter protection part, while a split-off part of the air bag cover device is released from a fixed part joined with the motor vehicle remains bound over the connecting section and shows a defined relation-and-movement behavior. Further, by backing up the carrier layer with the splinter protection part on its side away from the interior space, the optical impression of the occupants is unimpaired. Finally, the apparatus of the subject invention as well as the inventive process permit the manufacture of an air bag cover that rests in a mold base part without intermediate removal.

In an advantageous development of the air bag cover device of the subject invention, the carrier layer is made of a breakage resistant, rigid plastic material, preferably a polypropylene material.

With air bag covers of the subject invention it is expedient that the connecting part be constructed as a connecting strap with a corrugated section. In this manner, a relatively great elasticity or extensibility of the connecting section is possible.

In order to achieve an controlled bursting of the air bag cover of the subject invention it is expedient that the splinter protection part have a contour adapter in the impact zone of an unfolding air bag, and the side of the contour adapter facing the air bag be formed with an impact side aligned essentially at a right angle to the outlet direction of the air bag.

In a further development of an air bag cover according to the subject invention there are two connecting sections which are constructed as blades of a hinging mechanism for an opening of the cover in the direction of an air bag unit receiving the air bag.

In one embodiment of the air bag cover device of the subject invention the carrier layer is part of an instrument panel or dashboard.

In a further embodiment of an air bag cover according to the subject innovation the carrier layer is part of a door side lining.

In a further embodiment of an air bag cover device the carrier layer is part of a spar lining.

In one development of an apparatus according to the subject invention for the production of an air bag cover in the first cavity is introducible material for the formation of the splinter protection part and into the second cavity there is introducible material to the formation of the carrier layer. For the formation of the desired break lines, in the apparatus for the production of the air bag cover according to the subject invention there is a tool part formed with at least one blade tool insertable into the mold part cavity. In one execution of the process of the subject invention the desired-break lines are introduced in a carrier layer which is still plastically deformable or in a splinter protection part which is still plastically deformable.

### CONCISE DESCRIPTION OF THE DRAWINGS

Further suitable developments of the invention are described in the following examples of execution of the invention with reference to the figures of the drawing. In the drawings:

FIG. 1 shows in a sectioned side view an air bag unit and a dashboard which is equipped with a cover zone opening into the interior of a motor vehicle.

FIG. 2 shows in a sectioned side view the dashboard with the air bag unit according to FIG. 1, with a partially emerged air bag.

FIG. 3. shows in a sectioned side view, the instrument panel with the air bag unit according to FIG. 1 and FIG. 2 with the essentially completely emerged air bag.

FIG. 4 shows in a sectioned side view, an air bag unit and a dashboard which is equipped in a covering zone opening into the interior of a projectile path.

FIG. 5 shows in a cut-out, a section through an injection molding mold for the production of a dashboard according to one of the examples of execution given in FIGS. 1 to 4 in the formation of a splinter protection part.

FIG. 6 shows the injection-molding mold according to FIG. 5 in the formation of a carrier layer.

FIG. 7 shows the injection-molding mold according to FIG. 6 in the application desired break lines into the carrier layer.

### DETAILED DESCRIPTION OF THE INVENTION

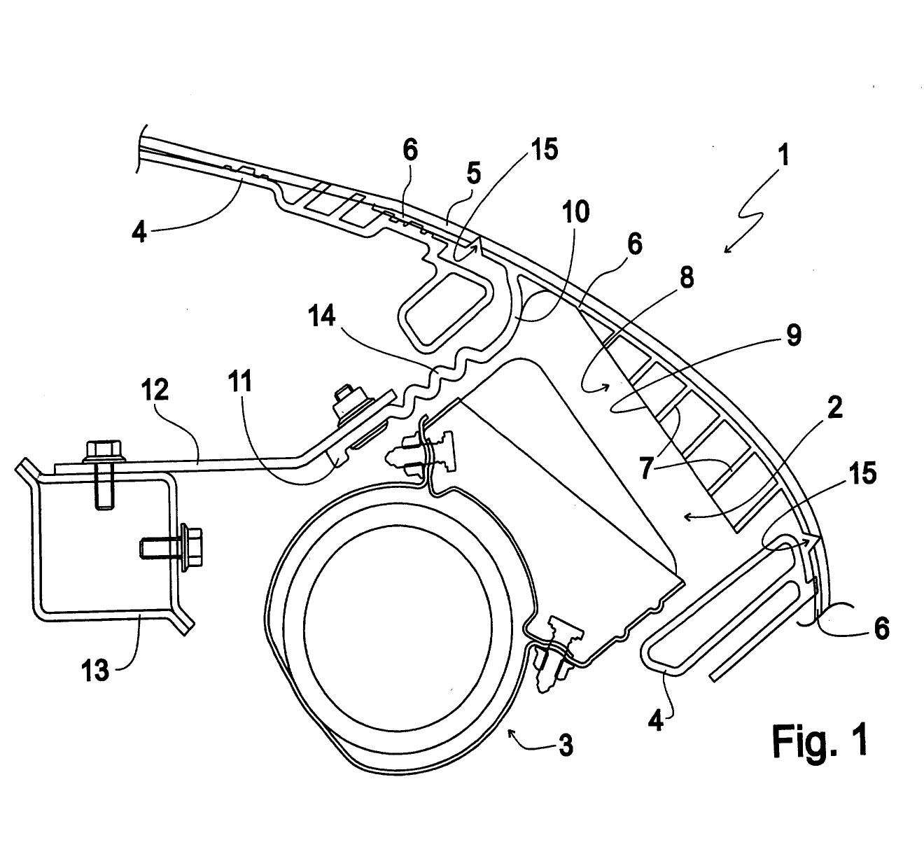

FIG. 1 shows in a sectioned side view, as an example of execution, an air bag cover device for motor vehicles, a dashboard 1 which has available a projectile path 2. In the zone of the projectile path 2 there is arranged an air bag unit 3, known per se and constructed in a conventional manner. The dashboard 1 is connected with the motor vehicle, over a dashboard support 4.

The dashboard 1 has a relatively rigid carrier layer 5, which is made preferably from a break-resistant and impact-proof polypropylene, which particularly at low temperatures of typically 0° C. to about −4° C., has the danger of splinter formation in a breakage. On its side facing the air bag unit 3, the dashboard 1 is equipped with a splinter protection part 6, which is firmly joined over all its surface with the carrier layer 5 and extends over the zone of the projectile path 2 as well as adjoining zones that form a coverage zone. The splinter protection part 6 is produced from a relatively flexible, elastic material, i.e., an elastomer.

The splinter protection part 6 has on its side away from the carrier, layer 5, webs 7 constructed in the zone of the projectile path 2, which form a contour adapter 8 with an impact side 9 aligned essentially parallel to the exit side of the air bag unit 3. Further, the splinter protection part 6 is equipped with a connecting flexible strap connection 10, which extends in the direction of the air bag unit 3 facing away from the carrier layer 5.

The strap 10 is connected by its free fastening end 11, as represented in FIG. 1, for example, over screw connections and an intermediate member 12, with a spar 13, which in turn is itself firmly joined with the motor vehicle. Preferably the connecting lash or strap 11 is formed with a corrugated section 14 for increased extensibility to longer lengths.

Finally, the dashboard 1 is equipped in the zone of the projectile path 2 with desired break lines 15, which extend from the side of the splinter protection part facing the air bag unit 3 on into the carrier layer 5, and that end relatively near the side facing the interior of the motor vehicle.

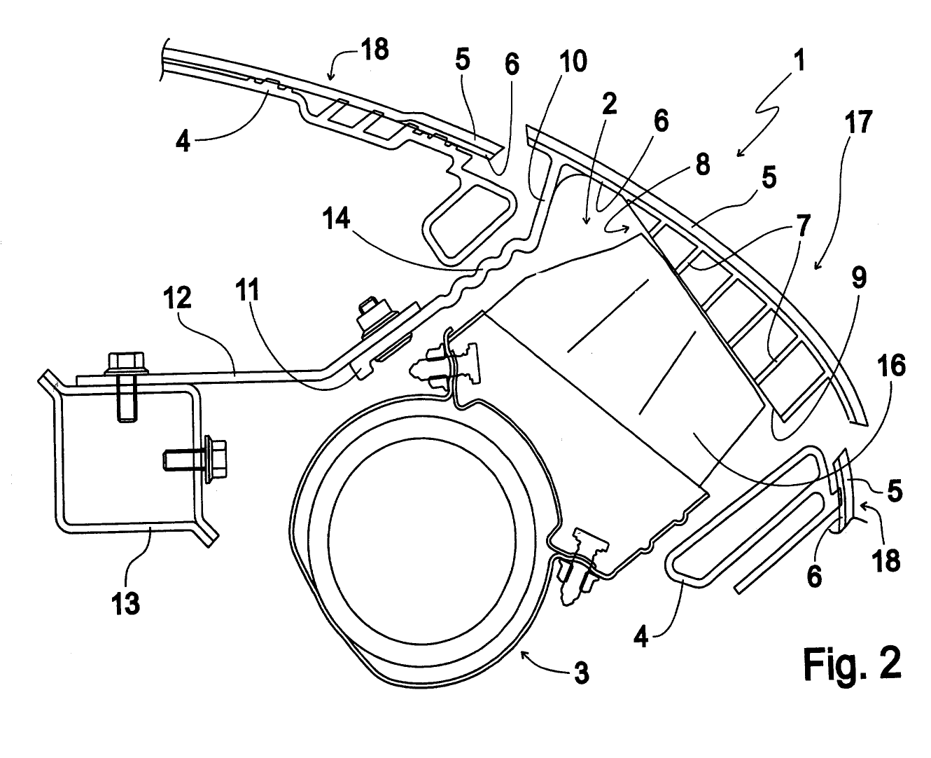

FIG. 2 shows, a sectioned side view, the instrument panel 1 with the air bag unit 3 according to FIG. 1, with an air bag that has partly emerged at the beginning of the expansion process. In its expansion, the air bag 16 strikes at first substantially overall upon the impact side 9, in which process, throughout the forces exerted on the impact side 9 of the splinter protection part 6, the burst-off part 17 of the dashboard 1 is lifted off under destruction of the dashboard fixed part 18 connected with the installment dashboard support 4 and by the stretching of the corrugated section 14 of the strap 10 as well as a certain stretching of the entire strap 10.

With the destruction of the connection between the burst-off part 17 and the fixed part 18 of the dashboard 1, brought about over the splinter-endangering carrier layer 5, the zones adjoining the desired-break lines 15 of the carrier layer 5 are further firmly joined with the splinter protection part 6, so that even with the formation of breaks in the carrier layer 5 there is prevented a bursting-off of fragments into the motor vehicle, with the resultant endangerment of its occupants.

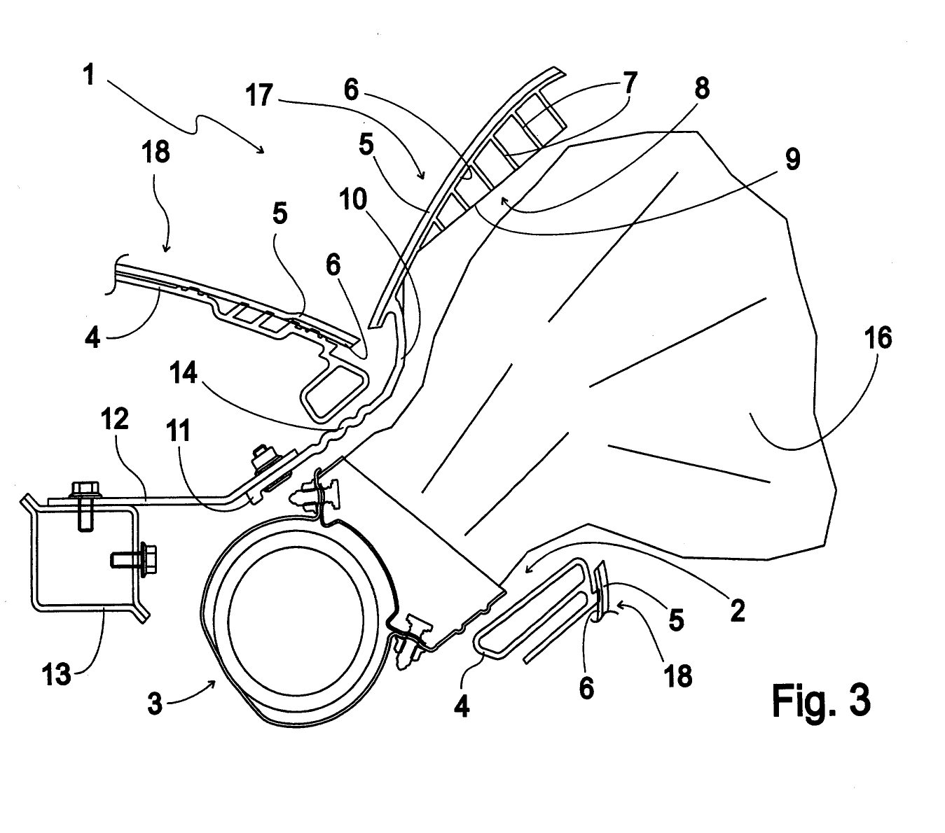

FIG. 3 shows, in a sectioned side view, the dashboard 1 with the air bag unit 3 according to FIG. 1 and FIG. 2, with the air bag 16 nearing the end of its expansion process and having essentially emerged and inflated. By reason of the expansion of the air bag 16, the burst-off part 17 situated within the desired break lines 15 flapped to the side in a defined rotation-and-movement process in a controlled manner, wherein the burst-off part 17 over the substantially maximally extended and stretched strap 10 and with a substantially completely stretched section 14, remains connected to the motor vehicle, and the occupants are not endangered.

After deflation of the air bag 16, the burst-off part will withdraw in the direction of the dashboard 1, so that the hazard of injury to the occupants is minimized.

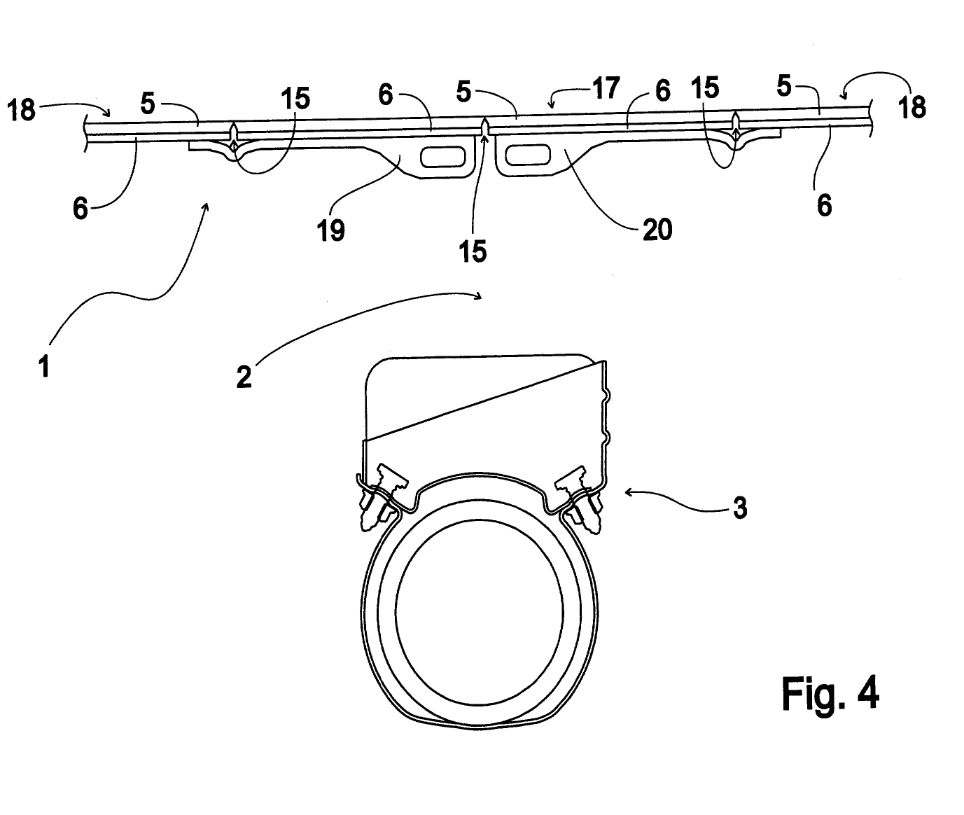

FIG. 4 shows a sectioned side view of an air bag unit 3 and a dashboard 1, equipped with a covering zone that opens into the interior of a projectile path 2. The dashboard 1 is equipped, in correspondence to the example of execution explained above with the aid of FIG. 1 to FIG. 3, with a splinter-prone carrier layer 5 as well as with a splinter protection part 6 joined over all its surface with the carrier layer 5. In the example of execution according to FIG. 4 the splinter protection part 6 is joined on its side facing in the direction of the air bag unit 3 with a first wing 19 and a second wing 20 of a folding mechanism known per se, in which the wings 19, 20 serve as connecting sections with the motor vehicle and are articulately joined with the motor vehicle. Between the wings 19, 20 there is, besides border-side desired break lines 15, a central desired break line 15, which are all formed by grooves extending through the splinter protection part 6 on into the carrier layer 5.

The wings 19, 20 move, driven by the following mechanism, before an exit of the air bag 16 in the direction of the air bag unit 3, in which process the connection between the now two-part burst-off part 17 and the fixed part 18 is destroyed over the residual material strength of the carrier layer 5. Also in this example of execution, because the full surface of the carrier layer 5 is backed or lined with the splinter protection part 6 in the zone of the desired break lines 15, there is prevented the uncontrolled bursting off of fragments of this carrier layer 5 that might endanger the occupant of the motor vehicle.

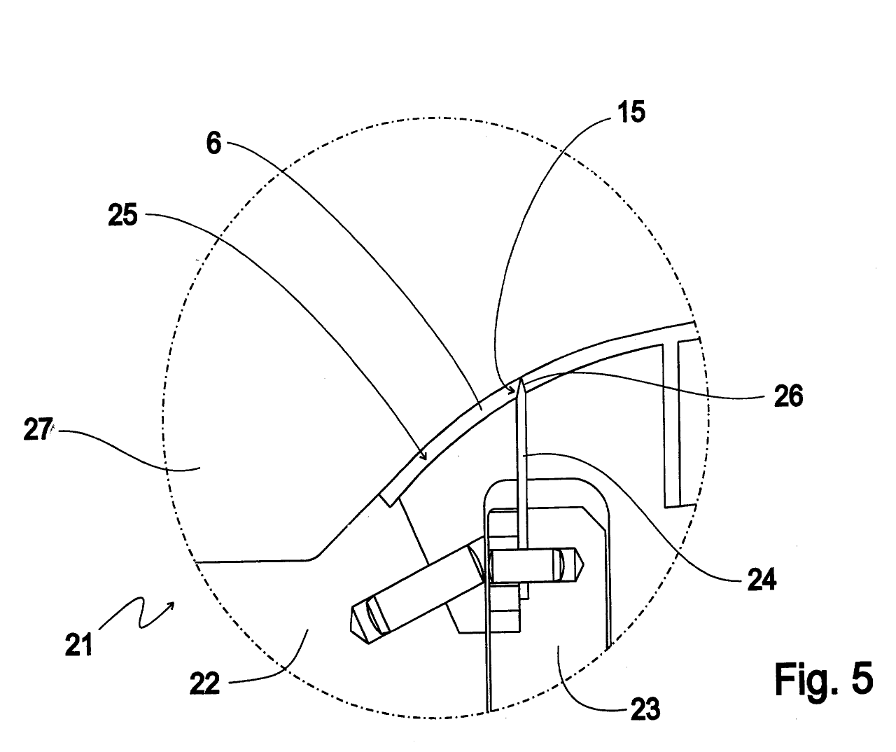

FIG. 5 shows in cutout a section through a mold 21 of the injection molding device constructed as an injection-molding mold for the production of an instrument panel 1 according to one of the embodiment according to FIGS. 1 and 4, in the construction of a splinter protection part 6. The injection molding mold 21 has a mold base part 22 in which, as blade tool with a blade tappet 23 activatable by thrusting, there is slidably borne an elongated blade 24. The blade 24 has on its end rising into a fist hollow space 25, provided as depression in the mod base 22 for the formation of the splinter prevention part 6, a blade edge 26 constructed with a number of raised parts and depressions.

Lying opposite the mold base part 22, the injection-molding mold 21 has a first mold counterpart 27 positionable with respect to the mold base part 22. In the arrangement according to FIG. 5 the border sides of the first mold counterpart 27, that are bounding on the first hollow space 25, rest on the border zones of the mold base part 22 surrounding the first hollow space 25, so that the first hollow space 25 is closed. On injection of the elastomer forming the splinter protection part 6 via a first feed unit, the blade edge 26 of the blade 24, with a residual material thickness of the splinter protection part 6 of about 0.2 millimeter, extends to near the first mold counterpart 27. During the cooling process following upon the injection of the elastomer, the blade 24 remains standing in this position, so that there is yielded a uniform surface with substantially constant thickness.

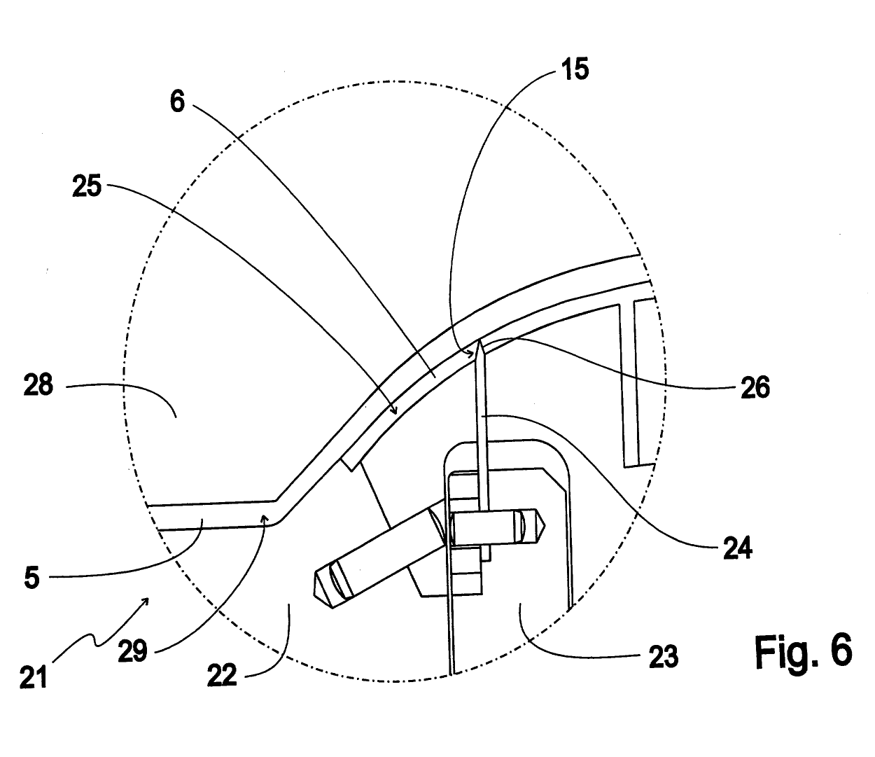

FIG. 6 shows the arrangement according to FIG. 5 with a second mold counterpart 28 offset with respect to the arrangement of the first mold counterpart 27. In the arrangement according to FIG. 6 there is now formed for the carrier layer 5 a second hollow space 29, into which the polypropylene material provided for the production of the carrier layer 5 can be injected. The injection of the polypropylene material for the carrier layer 5 takes place over a second feed unit while the elastomer for the splinter protection part 6 is still hot, typically about 4 seconds to 30 seconds after injection of that elastomer, which still typically has a temperature between about 80 degrees Celsius and about 200 degrees Celsius. In this manner there is achieved in the coverage zone a firm overall connection between the carrier layer 5 and the splinter protection part 6, that extends over the entire surfaces where they bound on each other.

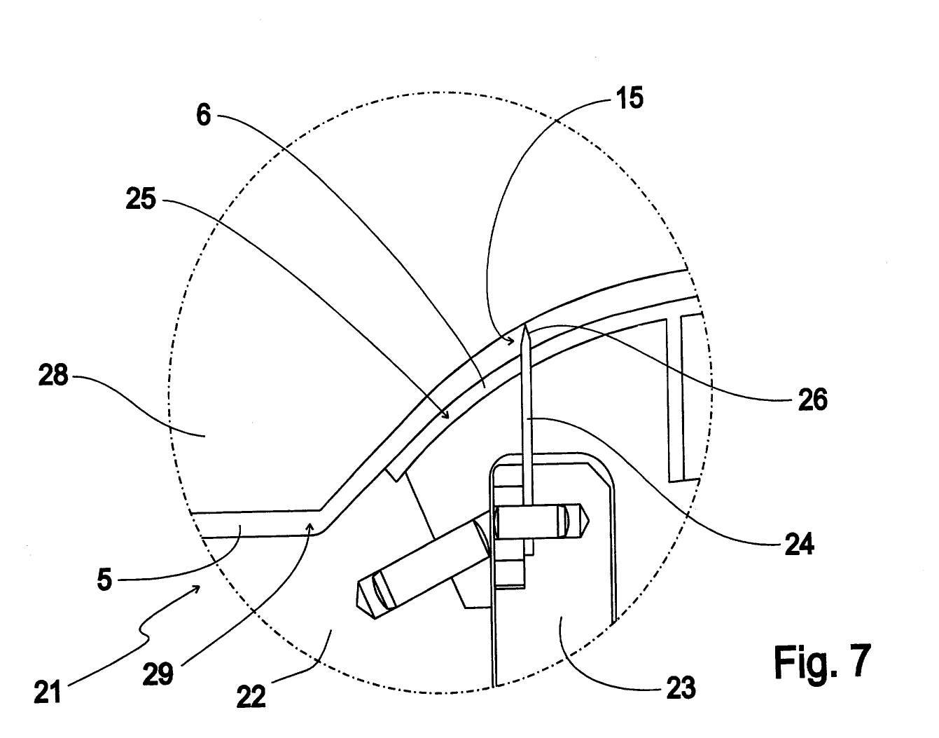

FIG. 7 shows the injection molding mold 21 in an arrangement of the mold base part 22 and of the second mold counterpart 28 according to FIG. 6, during the making of desired break lines 15 in the carrier layer 5, by thrusting the blade 24 forward about 4 seconds to about 30 seconds after injection of the polypropylene material for the carrier layer 5 while the polymer material of this carrier layer still is relatively soft, at least not completely hardened, its temperature typically being between about 100° C. and about 240° C. The blade edge 26 is advanced there to near the side of the carrier layer 5 facing the second mold counterpart 28, so that by reason of the relatively low residual material thickness in these zones the desired break lines are formed in the carrier layer 5 and in the splinter protection part 6. During the cooling, the blade 24 stands fast in this position until there is reached a temperature of about 80° C. The cooling occurs with a blade 24 standing fast in this position at up to about 80 degrees Celsius.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments and equivalents.

1. An air bag covering assembly for motor vehicles, with a carrier layer which is formed with desired break lines in a covering zone about an air bag, wherein on the side of a carrier layer facing the air bag a splinter protection part is secured, said splinter protection part being made from a substantially splinter-free elastic material, said splinter protection part extending at least over the covering zone, and the carrier layer and the splinter protection part are joined with one another, and that the splinter protection part has at least one connecting section joinable with the motor vehicle.

2. The air bag covering assembly of claim 1, wherein the carrier layer is made of break-resistant, rigid plastic material.

3. The air bag covering assembly of claim 1, wherein the connecting section has a corrugated section.

4. The air bag covering assembly of claim 1, wherein the connecting section is extensible.

4. The air bag covering assembly of claim 1, wherein the splinter protection part has, in an impact zone of an unfolding air bag, a contour adapter with a side facing the air bag constructed with an impact side aligned substantially at a right angle to the emergence direction of the air bag.

6. The air bag covering assembly of claim 1, wherein two connection sections are wings of a flap mechanism for an opening of the covering zone in the direction of an air bag unit receiving the air bag.

7. The air bag covering assembly of claim 1, wherein the carrier layer is part of an instrument panel.

8. The air bag covering assembly of claim 1, wherein the carrier layer is part of a door side lining.

9. The air bag covering assembly of claim 1, wherein the carrier layer is part of a spar covering.

10. An apparatus for the production of an air bag covering assembly with a mold having a mold base part as well as a mold counterpart, enclosing a mold part hollow space wherein a first mold counterpart encloses a first hollow space with the mold base part and a second mold counterpart encloses with the mold base part a second hollow space following upon the first hollow space, wherein the hollow spaces form the mold part hollow space for the air bag covering assembly.

11. The apparatus of claim 10, wherein material is introduced into the first hollow space for the formation of the splinter protection part, and material is introduced into the second hollow space for the formation of the carrier layer.

12. The apparatus of claim 10, wherein a tool part makes the desired break lines with at least one blade tool emplaceable in the mold part hollow space.

13. A method for the production of an air bag covering the assembly including the steps of forming a splinter protection part in a first hollow space of a mold, forming, after a cooling time, a carrier layer in a second hollow space following upon the first hollow space, and arranging the cooling time so that the carrier layer and the splinter protection part join with each other over all their adjoining surfaces.

14. The method of claim 13, wherein the desired break lines are made when carrier layer is still plastically deformable, and when a splinter protection part is still plastically deformable.
